(19) United States
(12) Patent Application Publication
(10) Pub. No.: US 2019/0049090 A1
(43) Pub. Date: Feb. 14, 2019

(54) VEHICLE LAMP ASSEMBLY

(71) Applicant: Ford Global Technologies, LLC, Dearborn, MI (US)

(72) Inventors: Venkatesh Krishnan, Canton, MI (US); Stuart C. Salter, White Lake, MI (US); Paul Kenneth Dellock, Northville, MI (US)

(73) Assignee: Ford Global Technologies, LLC

(21) Appl. No.: 15/673,510

(22) Filed: Aug. 10, 2017

(51) Int. Cl. F21S 8/10; B60Q 1/24; H05B 33/08; B60Q 1/26

(52) U.S. Cl. CPC F21S 48/2218; B60Q 1/24; H05B 33/0854; F21Y 2113/13; B60Q 1/2665; B60Q 2400/50; B60Q 2400/40; B60Q 1/2669

(57) ABSTRACT

A lamp assembly is provided herein. The lamp assembly includes a light source operably coupled to a panel of the vehicle. A luminescent structure is disposed on the panel and defines one or more indicia. The luminescent structure is configured to luminesce in response to receiving an excitation light emitted by the light source. A controller is configured to activate the light source based on an operational mode of the vehicle.

### FIELD OF THE INVENTION

The present disclosure generally relates to vehicle lamp assemblies, and more particularly, to vehicle lamp assemblies that may employ one or more luminescent structures.

### BACKGROUND OF THE INVENTION

Vehicle illumination may provide a wide range of functions for a user of the vehicle. It is therefore desired to implement such structures in vehicles for various applications.

### SUMMARY OF THE INVENTION

According to one aspect of the present disclosure, a lamp assembly is disclosed. The lamp assembly includes a light source operably coupled to a panel of a vehicle. A luminescent structure is disposed on the panel and defines one or more indicia. The luminescent structure is configured to luminesce in response to receiving an excitation light emitted by the light source. A controller is configured to activate the light source based on an operational mode of the vehicle.

According to another aspect of the present disclosure, a vehicle exterior member assembly is disclosed. The vehicle exterior member assembly includes a first light source disposed within a first housing. A second light source is disposed within a second housing. The first and second light sources are operably coupled with first and second luminescent structures, respectively. A controller is configured to activate the first and second light sources based on an operational mode of a vehicle.

According to yet another aspect of the present disclosure, a method of illuminating a vehicle lamp assembly is disclosed. The method includes detecting an operational mode of the vehicle. Next, the controller attempts to detect a person proximate the vehicle. An environmental light level surrounding the vehicle is detected. An indicia on a vehicle is illuminated when the vehicle is in a first operational mode, the person is detected, and a low-light condition exists.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1A is a side view of a luminescent structure rendered as a coating, according to some examples;

FIG. 1B is a top view of a luminescent structure rendered as a discrete particle, according to some examples;

FIG. 1C is a side view of a plurality of luminescent structures rendered as discrete particles and incorporated into a separate structure, according to some examples;

FIG. 2 is a perspective view of an automotive vehicle employing a lamp assembly in an exterior member of a vehicle, according to some examples;

FIG. 2A is an enlarged view of section IIA of FIG. 2 illustrating the exterior member with a plurality of light sources disposed therein;

FIG. 3 is an enlarged view of the lamp assembly illustrating the light sources illuminating indicia, according to some examples;

FIG. 4 is a cross-sectional view taken through line IV-IV of FIG. 3 further illustrating the light source, according to some examples;

FIG. 5 is an enhanced view of area V of FIG. 4 illustrating the light source configured as a projector lamp, according to some examples;

FIG. 6 is a block diagram of a vehicle employing the lamp assembly, according to some examples; and

FIG. 7 is a flow diagram of a method of operating the lamp assembly, according to some examples.

### DETAILED DESCRIPTION OF THE PREFERRED EXAMPLES

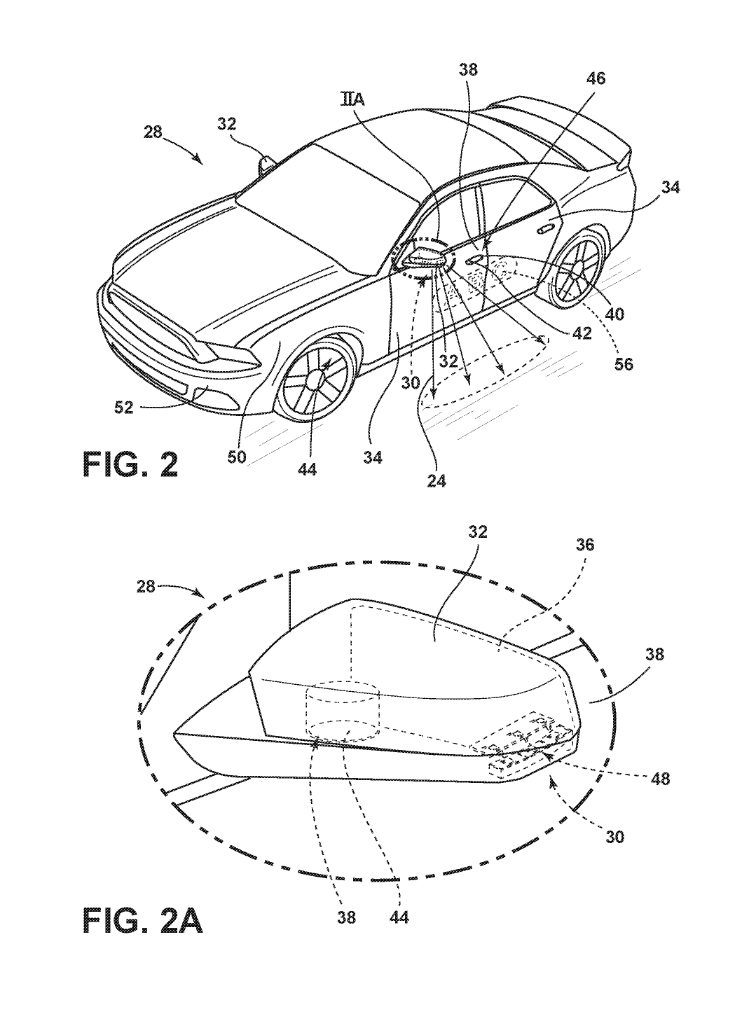

For purposes of description herein, the terms “upper,” “lower,” “right,” “left,” “rear,” “front,” “vertical,” “horizontal,” “inward,” “outward,” and derivatives thereof shall relate to the invention as oriented in FIG. 2. However, it is to be understood that the invention may assume various alternative orientations, except where expressly specified to the contrary. It is also to be understood that the specific devices and processes illustrated in the attached drawings, and described in the following specification are simply exemplary examples of the inventive concepts defined in the appended claims. Hence, specific dimensions and other physical characteristics relating to the examples disclosed herein are not to be considered as limiting, unless the claims expressly state otherwise.

As required, detailed examples of the present invention are disclosed herein. However, it is to be understood that the disclosed examples are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes a lamp assembly for a vehicle. The lamp assembly may advantageously employ a light source that projects onto the vehicle. The lamp assembly may further employ one or more luminescent structures that illuminate in response to pre-defined events. The one or more luminescent structures may be configured to receive an excitation light and re-emit a converted light at a different wavelength typically found in the visible wavelength spectrum.

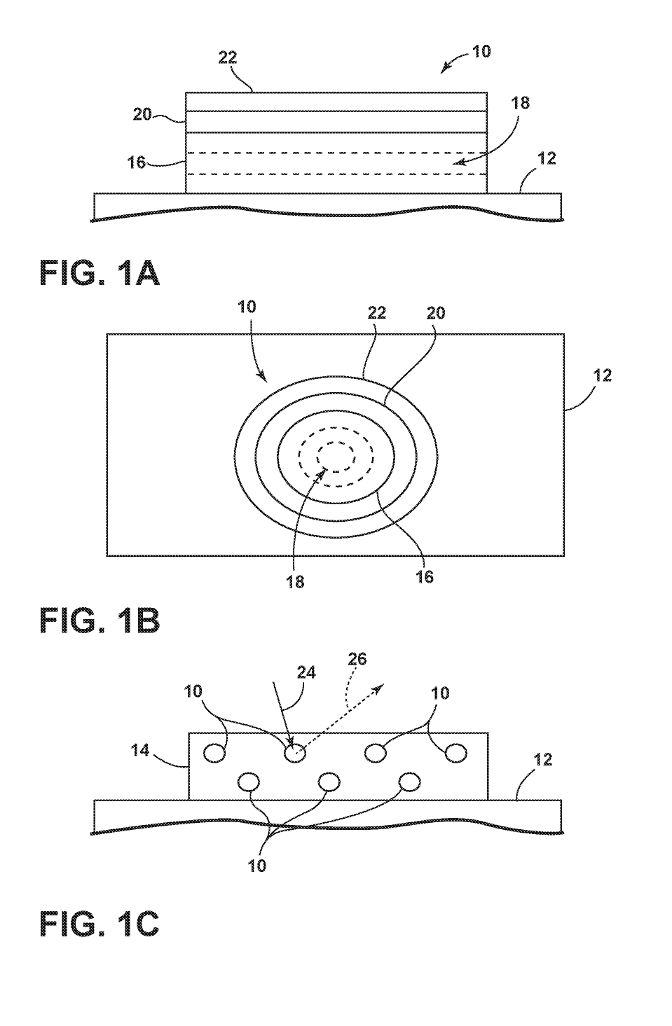

Referring to FIGS. 1A-1C, various exemplary examples of luminescent structures 10 are shown, each capable of being coupled to a substrate 12, which may correspond to a vehicle fixture or vehicle-related piece of equipment. In FIG. 1A, the luminescent structure 10 is generally shown rendered as a coating (e.g., a film) that may be applied to a surface of the substrate 12. In FIG. 1B, the luminescent structure 10 is generally shown as a discrete particle capable of being integrated with a substrate 12. In FIG. 1C, the luminescent structure 10 is generally shown as a plurality of discrete particles that may be incorporated into a support medium 14 (e.g., a film) that may then be applied (as shown) or integrated with the substrate 12.

At the most basic level, a given luminescent structure 10 includes an energy conversion layer 16 that may include one or more sublayers, which are exemplarily shown in broken lines in FIGS. 1A and 1B. Each sublayer of the energy conversion layer 16 may include one or more luminescent materials 18 having energy converting elements with phosphorescent or fluorescent properties. Each luminescent material 18 may become excited upon receiving an excitation light 24 of a specific wavelength, thereby causing the light to undergo a conversion process. Under the principle of down conversion, the excitation light 24 is converted into a longer-wavelength, converted light 26 that is outputted from the luminescent structure 10. Conversely, under the principle of up conversion, the excitation light 24 is converted into a shorter wavelength light that is outputted from the luminescent structure 10. When multiple distinct wavelengths of light are outputted from the luminescent structure 10 at the same time, the wavelengths of light may mix together and be expressed as a multicolor light.

The energy conversion layer 16 may be prepared by dispersing the luminescent material 18 in a polymer matrix to form a homogenous mixture using a variety of methods. Such methods may include preparing the energy conversion layer 16 from a formulation in a liquid carrier support medium 14 and coating the energy conversion layer 16 to a desired substrate 12. The energy conversion layer 16 may be applied to a substrate 12 by painting, screen-printing, spraying, slot coating, dip coating, roller coating, and bar coating. Alternatively, the energy conversion layer 16 may be prepared by methods that do not use a liquid carrier support medium 14. For examples, the energy conversion layer 16 may be rendered by dispersing the luminescent material 18 into a solid-state solution (homogenous mixture in a dry state) that may be incorporated in a polymer matrix, which may be formed by extrusion, injection molding, compression molding, calendaring, thermoforming, etc. The energy conversion layer 16 may then be integrated into a substrate 12 using any methods known to those skilled in the art. When the energy conversion layer 16 includes sublayers, each sublayer may be sequentially coated to form the energy conversion layer 16. Alternatively, the sublayers can be separately prepared and later laminated or embossed together to form the energy conversion layer 16. Alternatively still, the energy conversion layer 16 may be formed by coextruding the sublayers.

In various examples, the converted light 26 that has been down converted or up converted may be used to excite other luminescent material(s) 18 found in the energy conversion layer 16. The process of using the converted light 26 outputted from one luminescent material 18 to excite another, and so on, is generally known as an energy cascade and may serve as an alternative for achieving various color expressions. With respect to either conversion principle, the difference in wavelength between the excitation light 24 and the converted light 26 is known as the Stokes shift and serves as the principal driving mechanism for an energy conversion process corresponding to a change in wavelength of light. In the various examples discussed herein, each of the luminescent structures 10 may operate under either conversion principle.

Referring back to FIGS. 1A and 1B, the luminescent structure 10 may optionally include at least one stability layer 20 to protect the luminescent material 18 contained within the energy conversion layer 16 from photolytic and thermal degradation. The stability layer 20 may be configured as a separate layer optically coupled and adhered to the energy conversion layer 16. Alternatively, the stability layer 20 may be integrated with the energy conversion layer 16. The luminescent structure 10 may also optionally include a protective layer 22 optically coupled and adhered to the stability layer 20 or other layer (e.g., the conversion layer 16 in the absence of the stability layer 20) to protect the luminescent structure 10 from physical and chemical damage arising from environmental exposure. The stability layer 20 and/or the protective layer 22 may be combined with the energy conversion layer 16 through sequential coating or printing of each layer, sequential lamination or embossing, or any other suitable means.

According to various examples, the luminescent material 18 may include organic or inorganic fluorescent dyes including rylenes, xanthenes, porphyrins, and phthalocyanines. Additionally, or alternatively, the luminescent material 18 may include phosphors from the group of Ce-doped garnets such as YAG:Ce and may be a short-persistence luminescent material 18. For examples, an emission by Ce³⁺ is based on an electronic energy transition from 4D¹ to 4f¹ as a parity allowed transition. As a result of this, a difference in energy between the light absorption and the light emission by Ce³⁺ is small, and the luminescent level of Ce³⁺ has an ultra-short lifespan, or decay time, of 10⁻⁸ to 10⁻⁷ seconds (10 to 100 nanoseconds). The decay time may be defined as the time between the end of excitation from the excitation light 24 and the moment when the light intensity of the converted light 26 emitted from the luminescent structure 10 drops below a minimum visibility of 0.32 mcd/m². A visibility of 0.32 mcd/m² is roughly 100 times the sensitivity of the dark-adapted human eye, which corresponds to a base level of illumination commonly used by persons of ordinary skill in the art.

According to various examples, a Ce³⁺ garnet may be utilized, which has a peak excitation spectrum that may reside in a shorter wavelength range than that of conventional YAG:Ce-type phosphors. Accordingly, Ce³⁺ has short-persistence characteristics such that its decay time may be 100 milliseconds or less. Therefore, in various examples, the rare earth aluminum garnet type Ce phosphor may serve as the luminescent material 18 with ultra-short-persistence characteristics, which can emit the converted light 26 by absorbing purple to blue excitation light 24 emitted from the light source 48. According to various examples, a ZnS:Ag phosphor may be used to create a blue-converted light 26. A ZnS:Cu phosphor may be utilized to create a yellowish-green converted light 26. A Y₂O₂S:Eu phosphor may be used to create red converted light 26. Moreover, the aforementioned phosphorescent materials may be combined to form a wide range of colors, including white light. It will be understood that any short-persistence luminescent material known in the art may be utilized without departing from the teachings provided herein.

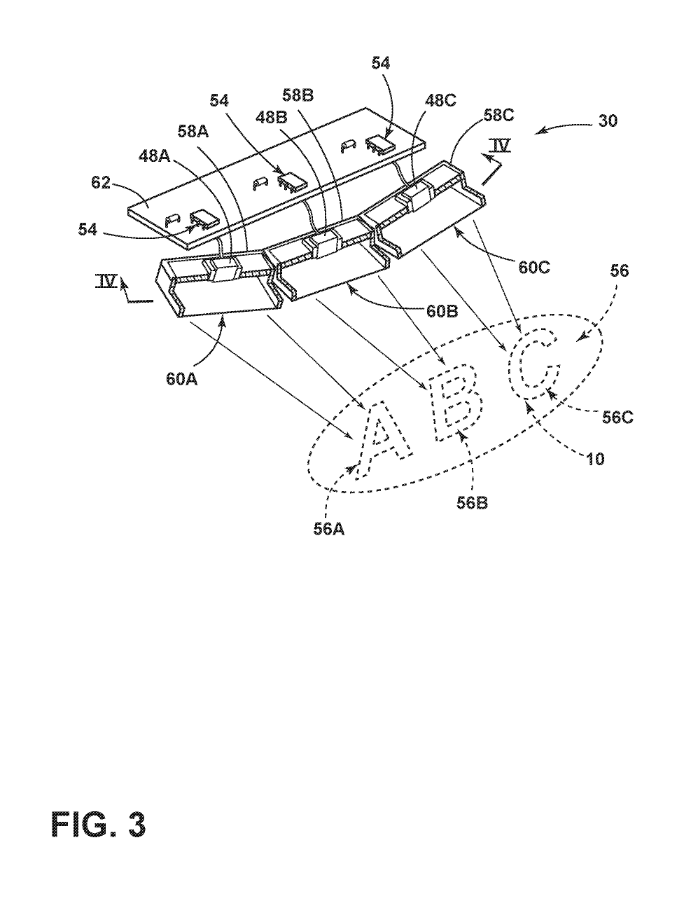

Additionally, or alternatively, the luminescent material 18, according to various examples, disposed within the luminescent structure 10 may include a long-persistence luminescent material 18 that emits the converted light 26, once charged by the excitation light 24. The excitation light 24 may be emitted from any excitation source (e.g., any natural light source, such as the sun, and/or any artificial light source 48 (FIG. 3). The long-persistence luminescent material 18 may be defined as having a long decay time due to its ability to store the excitation light 24 and release the converted light 26 gradually, for a period of several minutes or hours, once the excitation light 24 is no longer present.

The long-persistence luminescent material 18, according to various examples, may be operable to emit light at or above an intensity of 0.32 mcd/m² after a period of 10 minutes. Additionally, the long-persistence luminescent material 18 may be operable to emit light above or at an intensity of 0.32 mcd/m² after a period of 30 minutes and, in various examples, for a period substantially longer than 60 minutes (e.g., the period may extend 24 hours or longer, and in some instances, the period may extend 48 hours). Accordingly, the long-persistence luminescent material 18 may continually illuminate in response to excitation from any light source 48 that emits the excitation light 24, including, but not limited to, natural light sources (e.g., the sun) and/or any artificial light source 48. The periodic absorption of the excitation light 24 from any excitation source may provide for a substantially sustained charge of the long-persistence luminescent material 18 to provide for consistent passive illumination. In various examples, a light sensor may monitor the illumination intensity of the luminescent structure 10 and actuate an excitation source when the illumination intensity falls below 0.32 mcd/m², or any other predefined intensity level.

The long-persistence luminescent material 18 may correspond to alkaline earth aluminates and silicates, for examples, doped di-silicates, or any other compound that is capable of emitting light for a period of time once the excitation light 24 is no longer present. The long-persistence luminescent material 18 may be doped with one or more ions, which may correspond to rare earth elements, for examples, Eu2+, Tb3+, and/or Dy3. According to one non-limiting exemplary example, the luminescent structure 10 includes a phosphorescent material in the range of about 30% to about 55%, a liquid carrier medium in the range of about 25% to about 55%, a polymeric resin in the range of about 15% to about 35%, a stabilizing additive in the range of about 0.25% to about 20%, and performance-enhancing additives in the range of about 0% to about 5%, each based on the weight of the formulation.

The luminescent structure 10, according to various examples, may be a translucent white color, and in some instances reflective, when unilluminated. Once the luminescent structure 10 receives the excitation light 24 of a particular wavelength, the luminescent structure 10 may emit any color light (e.g., blue or red) therefrom at any desired brightness. According to various examples, a blue emitting phosphorescent material may have the structure Li₂ZnGeO₄ and may be prepared by a high-temperature solid-state reaction method or through any other practicable method and/or process. The afterglow may last for a duration of 2-8 hours and may originate from the excitation light 24 and d-d transitions of Mn2+ ions.

According to an alternate non-limiting exemplary example, 100 parts of a commercial solvent-borne polyurethane, such as Mace resin 107-268, having 50% solids polyurethane in toluene/isopropanol, 125 parts of a blue-green long-persistence phosphor, such as Performance Indicator PI-BG20, and 12.5 parts of a dye solution containing 0.1% Lumogen Yellow F083 in dioxolane may be blended to yield a low rare earth mineral luminescent structure 10. It will be understood that the compositions provided herein are non-limiting examples. Thus, any phosphor known in the art may be utilized within the luminescent structure 10 without departing from the teachings provided herein. Moreover, it is contemplated that any long-persistence phosphor known in the art may also be utilized without departing from the teachings provided herein.

Referring to FIGS. 2 and 2A, a vehicle 28 is generally illustrated employing a lamp assembly 30, according to some examples. The vehicle 28 shown is one example of a passenger vehicle 28 having a pair of exterior members 32 mounted on opposing lateral sides of the vehicle 28 generally near the front side of the front passenger doors 34, which may be configured to house a mirror 36 and/or a sensor assembly 38 therein for detecting nearby objects. Passenger doors 34 each include a handle 40 with a latch mechanism to enable a user to engage and unlatch the latch mechanism to open the door 34 for access to a passenger compartment. The handle 40 is shown including a proximity sensor 42, such as a capacitive sensor, for detecting the hand of the user in close proximity to the handle 40. However, in some examples, the latch may be a mechanical latch and/or any other type of latch known in the art. In the depicted example, the vehicle 28 is illustrated as a sedan, but it will be understood that the vehicle 28 may be a truck, van, sport utility vehicle, or any other type of vehicle 28 without departing from the scope of teachings provided herein.

With further reference to FIGS. 2 and 2A, the vehicle 28 may be a manually operated vehicle (i.e. using a human driver) or may be autonomously driven by an onboard controller. Additionally, or alternatively, the vehicle 28 may be remotely controlled (e.g., via an operator in a different location). Autonomous vehicles sense the environment around them using a variety of sensors. In autonomous examples, the sensor assembly 38 may incorporate a light detection and ranging (LIDAR) system 44 that measures distance by illuminating a target with laser light. Such laser light may exist in the near-infrared and/or infrared wavelength band of the electromagnetic spectrum. The sensor assembly 38 may additionally, and/or alternatively, include any other type of sensor for detecting objects proximate the vehicle 28, including but not limited to, proximity sensors and/or imaging sensors.

The lamp assembly 30 may be installed within the exterior member 32, generally in a position configured to project excitation light 24 towards a panel 46 of the vehicle 28, such as an outer panel of the door 34 from one or more light sources 48 within a housing of the exterior member 32. In the example shown, three light sources 48A, 48B, 48C (FIG. 3) are configured in a linear array, each oriented to illuminate the vehicle 28. In some examples, the first light source 48A emits a first wavelength of excitation light 24, the second light source 48B emits a second wavelength of excitation light 24, and the third light source 48C emits a third wavelength of excitation light 24. While three light sources 48A, 48B, 48C are shown and described herein as part of the lamp assembly 30, it will be appreciated that one or more light sources 48A, 48B, 48C may be employed in various configurations and orientations. It will further be appreciated that the light sources 48A, 48B, 48C may be located at different locations on the vehicle 28, such as in the vehicle door handle 40, the door 34 itself, a side fender 50, a bumper 52, a roof rail or other locations sufficient to project excitation light 24 towards a desired location.

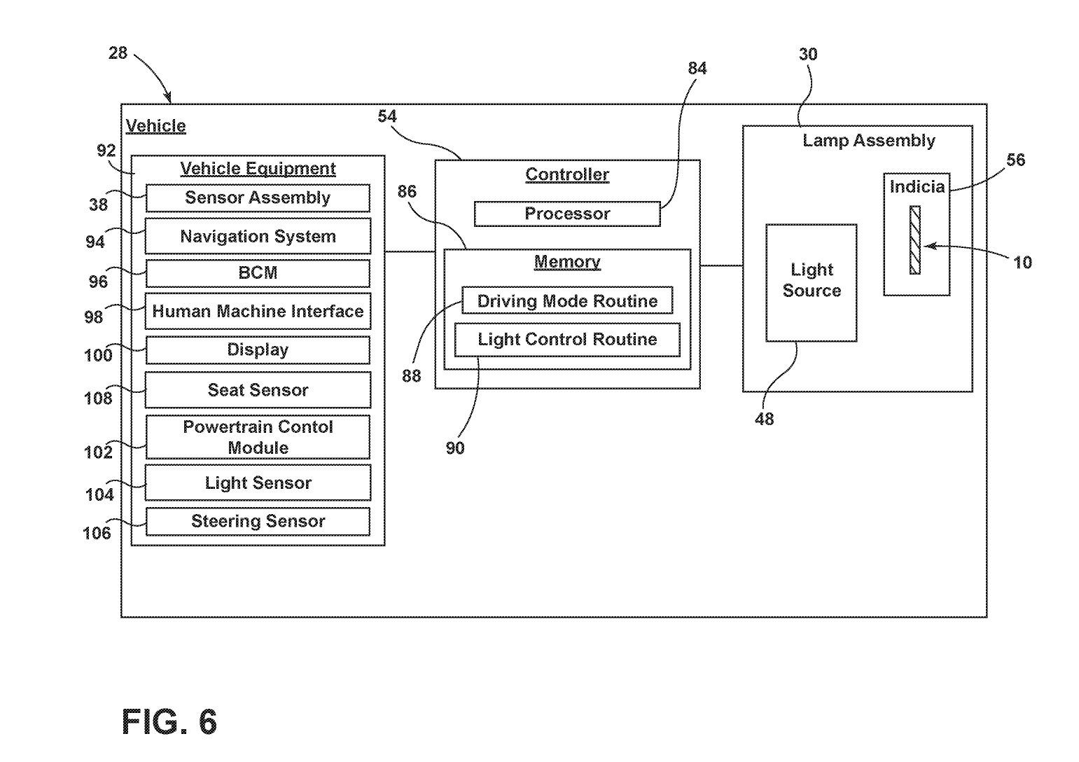

With further reference to FIGS. 2 and 2A, the lamp assembly 30 is controlled by a controller 54 (FIG. 6) to simultaneously or independently activate the one or more light sources 48A, 48B, 48C. The one or more light sources 48A, 48B, 48C may emit excitation light 24 towards one or more indicia 56 disposed on the panel 46 of the vehicle 28. The indicia 56 may define messages that may be independently illuminable by the one or more light sources 48A, 48B, 48C. For example, a first message may be illuminated to warn pedestrians of the autonomous mode of the vehicle 28. Further, a second message may be provided to warn a pedestrian of the approaching vehicle once the pedestrian, or another object, is detected. In some circumstances, persons proximate the vehicle 28 may not notice the vehicle 28 and/or be distracted, and the presence of the messages may provide additional notification to the proximate person of the vehicle 28. Moreover, the messages may be provided in low-light conditions, such as at night, to provide additional visibility of the vehicle 28 to pedestrians and cyclists proximate the vehicle 28. In some examples, the messages may be updated based on the operational mode of the vehicle (e.g., manual or autonomous mode), the object detected (e.g., a first message may be provided for a cyclist and a second message may be provided for a pedestrian), and/or the circumstance upon which the vehicle 28 approaches the detected object.

Referring to FIG. 3, the lamp assembly 30 is illustrated having three light sources 48A, 48B, 48C for illuminating the vehicle 28. The lamp assembly 30 includes a first light source 48A, a second light source 48B, and a third light source 48C, all shown arranged in a linear array so as to provide excitation light 24 to the panel 46 of the vehicle 28. For example, fluorescent lighting, light-emitting diodes (LEDs), organic LEDs (OLEDs), polymer LEDs (PLEDs), laser diodes, quantum dot LEDs (QD-LEDs), solid-state lighting, a hybrid of these or any other similar device, and/or any other form of lighting may be utilized within the lamp assembly 30. Further, various types of LEDs are suitable for use as the light sources 48 including, but not limited to, top-emitting LEDs, side-emitting LEDs, and others.

Each of the light sources 48A, 48B, 48C may include a housing 58A, 58B, 58C. Optics may be arranged within light output windows 60A, 60B, 60C of the corresponding light sources 48A, 48B, 48C, respectively, such that excitation light 24 output by the light sources 48A, 48B, 48C is directed towards the desired location. The lamp assembly 30 may include a printed circuit board (PCB) 62 containing the controller 54 having control circuitry including LED drive circuitry for controlling activation and deactivation of the light sources 48A, 48B, 48C. The controller 54 may be disposed in the vehicle 28 and/or within the exterior member 32. The circuit board 62 may be configured in any fashion known in the art including, but not limited to, any flexible PCB and/or rigid PCB.

The controller 54 may activate the light sources 48 based on a plurality of inputs and may modify the intensity of the emitted wavelengths of excitation light 24 by pulse-width modulation, current control, and/or any other method known in the art. In various examples, the controller 54 may be configured to adjust a color and/or intensity of the excitation light 24 by sending control signals to adjust an intensity or energy output level of the light sources 48. According to various examples, the controller 54 may increase the intensity of excitation light 24 emitted from any of the light sources 48 up to five times steady state. According to various examples, multicolored light sources 48, such as Red, Green, and Blue (RGB) LEDs that employ red, green, and blue LED packaging may be used to generate various desired colors of light outputs from a single light source 48, according to known light color mixing techniques.

In operation, any of the light sources 48A, 48B, 48C may be configured to emit excitation light 24 towards the indicia 56, which may be defined by the luminescent structure 10. The luminescent structure 10 luminesces in response to receiving the excitation light 24. The wavelength of the excitation light 24 may differ in length from that of the converted light 26 that is emitted from the luminescent structure 10.

Referring still to FIG. 3, the forward window 60A is configured to direct excitation light 24 towards a first indicia 56A. The middle window 60B is configured to direct excitation light 24 and/or converted light 26 towards a second indicia 56B. The rearward window 60C may be directed towards a third indicia 56C. The vehicle door handle 40 may have an additional luminescent structure 10 thereon that luminesces upon receiving excitation light 24 from the third light source 48C. It will be appreciated, however, that the lamp assembly 30 may have any number of light sources 48A, 48B, 48C directed at any feature of the vehicle 28 and/or any area surrounding the vehicle 28. Moreover, each light source 48A, 48B, 48C may illuminate independently, or in conjunction with one another, without departing from the scope of the present disclosure.

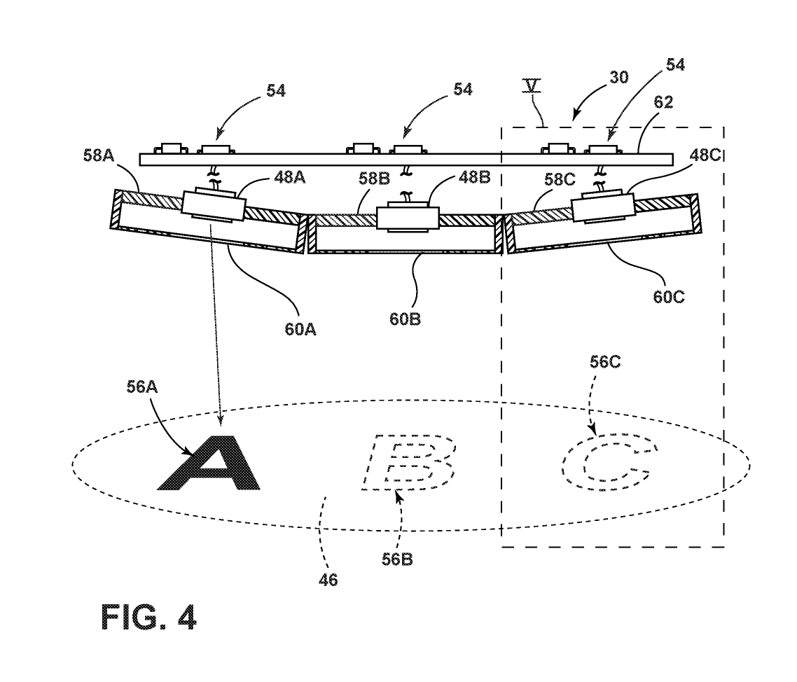

Referring to FIG. 4, each light output window 60A, 60B, 60C may incorporate an interchangeable lens, and can be a concave lens, convex lens, cylindrical lens, or an impression or projection specific optical member 68, depending upon the usability and application. The lens may enable one to attain indicia 56A, 56B, 56C, images, messages, curves, etc., projected onto a panel 46 of the vehicle 28. As provided herein, the indicia 56A, 56B, 56C may notify persons and/or objects proximate the vehicle 28 of an operational mode of the vehicle 28. The projections may occur in low-light conditions when it may be difficult to visibly notice that a driver of the vehicle 28 is not present (i.e., the vehicle 28 is operating in an autonomous mode). Moreover, an occupant may be sitting in the driver's seat of the vehicle 28 but not controlling one or more features of the vehicle 28. In such circumstances, the indicia 56A, 56B, 56C providing information as to the operational mode or autonomous feature may be provided to proximate persons and/or objects. The additional notification may provide additional safety and/or additional marketing of the vehicle 28.

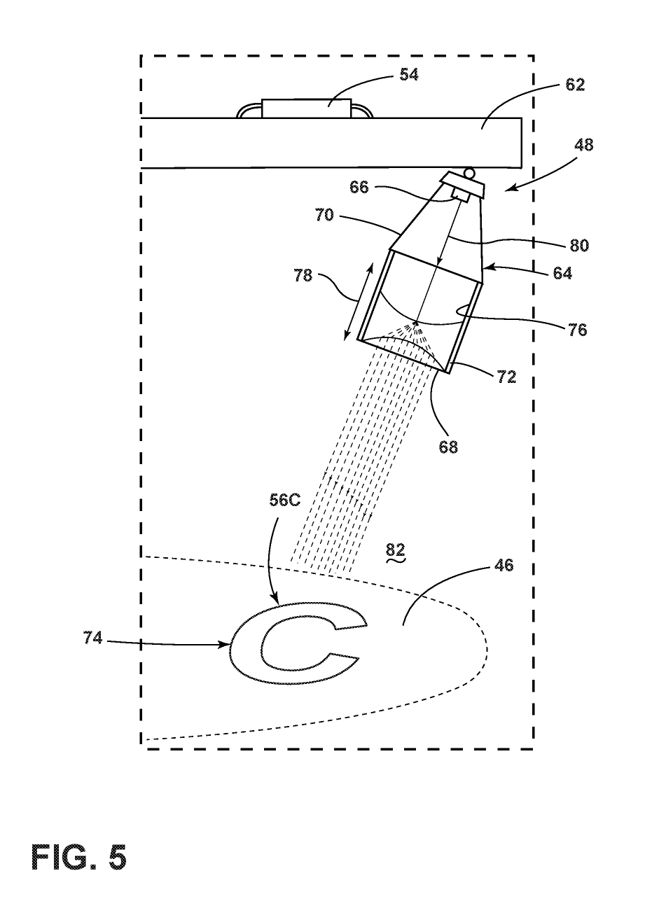

Referring to FIG. 5, the light source 48 may be configured as one or more projector lamps 64. The projector lamp 64 may produce images on the panel 46 of the vehicle 28. The images may include messages, notifications, alerts, emblems, and/or any other desired indicia 56, as provided herein. The projector includes a projector light source 66, an optical member 68, a connector casing 70, and an enclosure 72. However, any other type of projector known in the art may be utilized. According to various examples, the projector lamp 64 may include more than one projector light source 66 forming a single light source unit for providing a projection 74 through multiple light beams. In addition, the casing 70 can enable the light source 66 to be replaced by different light sources 48 having different color characteristics, wavelength, intensity, etc., enabling the possibility of a broad range of variations in projections, eventually aiming to enhance visual appeal to a viewer.

The optical member 68 may be similarly configured to be housed within the enclosure 72, which may be integrally formed with the casing 70. Further, an inner wall 76 of the enclosure 72 may include tracks or rails over which the optical member 68 can travel back and forth in the direction of the arrow 78 shown in FIG. 5. It is understood that such travel or movability, in relation to the projector light source 66, is configured to vary the size of the projection 74. Particularly, such movability enabled through the tracks or rails allows focusing the projection 74 on the panel 46 as well.

The light beam 80 emitted from the projector light source 66 can be a monochromatic beam of light, such as a laser, and accordingly, the light beam 80 can be a laser beam, configured to deliver a specific wavelength of visible light. This wavelength establishes a laser's color, as seen by the eye, by emitting light in a beam 80. Furthermore, the laser adopted in the projector lamp 64 may be modulated for human viewing and application, particularly having no or negligible effects to those who may view the light. In other examples, any other type of light source may be utilized, including red, blue, and green packaged LEDs.

The optical member 68 includes interchangeable lenses, and can accordingly be at least one of a concave lens, convex lens, cylindrical lens, or an impression or projection specific optical member 68, depending upon the usability and application. Particularly, optical members, such as the optical member 68 may enable one to attain images, messages, curves, etc., projected onto a surface, such as the panel 46. In addition, the optical member 68 may include a Fresnel lens composed of a number of small lenses arranged to make a lightweight lens of large diameter and short focal length suitable to be employed for projections according to the examples of the present disclosure.

During an operation of the projector lamp 64, the at least one projector light source 66 employed therein emits the light beam 80. The light beam 80 reaches the optical member 68. Subsequently, the optical member 68, receiving the light beam 80, refracts the beam 80, causing the beam to form refracted rays 82, while enabling the beam 80 to travel either in its original direction, or deflect, based according to the beam's angle of incidence on the optical member 68. The optical member 68 having an impression of at least an image, message, curve, etc., causes the refracted rays 82 to carry the impression towards the panel 46, thereby forming the projection 74. The refracted rays 82, thus formed by the light beam 80 passing across the impression, cause the impression to be projected on the panel 46, allowing the impression specific projection 74 to be visually viewed by a viewer (i.e., occupant). According to some examples, the projector may pivot or have any fixed axis such that the projector may be operably coupled to the panel 46.

Referring to FIG. 6, the vehicle 28 may be a manually operated vehicle (i.e. using a human driver) or may be autonomously driven by an onboard controller 54. Additionally, or alternatively, the vehicle 28 may be remotely controlled (e.g., via an operator located in a different location). The vehicle 28 generally includes the controller 54 having a processor 84 and a memory 86, the memory 86 including one or more forms of computer-readable media, and storing instructions executable by the processor 84 for performing various operations. The controller 54 may generally be configured for communications on a controller area network (CAN) bus or the like. The controller 54 may also have a connection to an onboard diagnostics connector (OBD-II). Via the CAN bus, OBD-II, and/or other wired or wireless mechanisms, the controller 54 may transmit messages to various devices in the vehicle 28 and/or receive messages from the various devices, e.g., controllers, actuators, sensors, electronic devices, etc., including data collectors. In addition, the controller 54 may be configured for communicating with a network, which may include various wired and/or wireless networking technologies, e.g., cellular, Bluetooth, wired and/or wireless packet networks, etc.

The controller 54 may be a dedicated or shared controller and may include the processor 84 and memory 86, according to some examples. It should be appreciated that the controller 54 may include control circuitry such as analog and/or digital control circuitry. The memory 86 may include one or more routines, such as a driving mode routine 88 and/or a light control routine 90. According to some examples, the driving mode routine 88 may determine whether the vehicle 28 is being operated in under an autonomous mode and/or a manual mode. The light control routine 90 may illuminate the light source 48 in a plurality of wavelengths based on the operational mode of the vehicle 28.

A variety of vehicle equipment 92 may be in communication with the controller 54. For example, various controllers 54 in the vehicle 28 may operate as data collectors to provide data via the CAN bus, e.g., data relating to vehicle speed, acceleration, etc. Further, sensors or the like, global positioning system (GPS) equipment, navigation systems 94, etc., could be included in the vehicle 28 and configured as data collectors to provide data directly to the controller 54, e.g., via a wired or wireless connection. Data provided by the sensor assembly 38 could include mechanisms such as RADAR, LIDAR 44 (FIG. 2), sonar, etc. sensors that could be deployed to measure a distance between the vehicle 28 and other vehicles or objects. Yet other sensor data collectors could include cameras, breathalyzers, motion detectors, etc., i.e., data collectors to provide data for evaluating a condition or state of a vehicle 28 operator. In addition, the data collectors may include sensors to detect a position, a change in position, a rate of change in position, etc., of vehicle components such as a steering wheel, brake pedal, accelerator, gearshift lever, etc.

With continued reference to FIG. 6, the controller 54 may communicate with the vehicle equipment 92 to receive information and illuminate the light assembly based on the information. In the depicted examples, the vehicle equipment 92 includes the navigation system 94, a body control module (BCM) 96, a human machine interface (HMI) 98, a display 100, a powertrain control module (PCM) 102, a light sensor 104, a steering sensor 106, and/or a seat sensor 108, each of which provides information to the controller 54 that may be used to determine the operation of the lamp assembly 30. For example, the navigation system 94 may provide the controller 54 with information related to the progress of a trip (e.g., ETA, distance, etc.). The navigation system 94 may also cooperate with the lamp assembly 30 such that the lamp assembly 30 is illuminated as the vehicle 28 begins to operate and/or move in an autonomous mode. The BCM 96 and/or PCM 102 may provide the controller 54 with information related to the vehicle 28 such as a door status (e.g., locked/unlocked), a seat belt status (e.g., buckled/unbuckled), a vehicle speed, etc. to determine whether a person is disposed within the vehicle 28 and/or operating (or capable of operating) the vehicle 28.

With further reference to FIG. 6, the vehicle 28 may additionally include the HMI 98 that may be used for controlling a plurality of functions within the vehicle 28, including, but not limited to, air conditioning settings, seat settings, sound settings, and/or navigational settings. The HMI 98 may also include a display 100 that may provide any desired information about the settings and/or any other information about the vehicle 28. The display 100 may also provide any desired information about the lamp assembly 30. Moreover, the display 100 may provide information pertaining to the current trip while the vehicle 28 is operated in an autonomous mode.

The seat sensor 108, which includes, but is not limited to, any type of proximity sensor, seat airbag sensor, pressure sensor, etc., may be utilized for initiating illumination of the lamp assembly 30. For example, if the occupant is not disposed on a driver's seat, the lamp assembly 30 may illuminate to indicate the lack of a person within a position to operate the vehicle 28 (e.g., the driver's seat).

In some examples, the vehicle 28 includes a light sensor 104 that may be utilized for varying the intensity of light 26 emitted from the lamp assembly 30. The light sensor 104 detects the environmental lighting conditions, such as whether the vehicle 28 is in day-like conditions (i.e., higher light level conditions) and/or whether the vehicle 28 is in night-like conditions (i.e., lower light level conditions). The light sensor 104 can be of any suitable type and can detect the day-like and night-like conditions in any suitable fashion. According to some examples, the colors of light and/or intensities of light emitted from the lamp assembly 30 may be varied based on the detected conditions. Moreover, the light source 48 may be activated in low-light conditions and when the vehicle 28 is operating in a mode that is indicated by the lamp assembly 30, such as an autonomous mode. The light sensor 104 may be integrated into the vehicle 28 or into the lamp assembly 30. Moreover, the intensity of excitation light 24 may additionally, or alternatively, be varied with the initiation of the vehicle's headlights.

With further reference to FIG. 6, the lamp assembly 30 may include one or more light sources 48 that illuminate the one or more indicia 56 of the lamp assembly 30, which may be defined by one or more luminescent structures 10. In response, the luminescent structures 10 may be configured to convert excitation light 24 received from the associated light source 48 into light having a wavelength in the visible spectrum. In some examples, a plurality of luminescent structures 10 may produce luminescence in response to a different wavelength of excitation light 24 emitted from the light source 48. Accordingly, the one or more indicia 56 may independently and/or contemporaneously luminesce.

In operation, the lamp assembly 30 may signify an operational mode of the vehicle 28. For example, the indicia 56 may be disposed on the vehicle 28 and illuminated in one mode while unilluminated in the other in order to notify proximate vehicles and persons about the operational mode of the vehicle 28. Furthermore, indicia 56 may be non-visible in an unilluminated mode and visible once illuminated by the one or more light sources 48.

In some examples, the light source 48 may emit significant intensities of excitation light 24 to ensure that the luminescent structure 10 is luminescing near the full capacity of the luminescent structure 10 such that the indicia 56 are visible during all conditions. Since lighting conditions may vary depending on a plurality of factors including, but not limited to, the current time, date, and weather conditions, the intensity of excitation light 24 emitted from the light source 48 may be adjusted by the controller 54 such that illumination of the luminescent structure 10 may be noticed under any condition. For example, the light intensity in Florida during a clear summer afternoon will generally be higher than the light intensity in Michigan during an overcast winter morning. Thus, by making this type of information known to the controller 54, the controller 54 can adjust any light source 48.

According to various examples, the luminescent structure 10 discussed herein is substantially Lambertian, that is, the apparent brightness of the luminescent structure 10 is substantially constant regardless of an observer's angle of view. As described herein, the color of the converted light 26 may be significantly dependent on the particular luminescent materials 18 utilized in the luminescent structure 10. Additionally, a conversion capacity of the luminescent structure 10 may be dependent on a concentration of the luminescent material 18 utilized in the luminescent structure 10. By adjusting the range of intensities that may excite the luminescent structure 10, the concentration, types, and proportions of the luminescent materials 18 in the luminescent structure 10 discussed herein may be operable to generate a range of color hues of the excitation light 24 by blending the first wavelength with the second wavelength.

As described herein, the color of the converted light 26 may be significantly dependent on the particular luminescent material 18 utilized in the luminescent structure 10. Additionally, a conversion capacity of the luminescent structure 10 may be significantly dependent on a concentration of the luminescent materials 18 utilized in the luminescent structure 10. By adjusting the range of intensities that may be emitted from the one or more light sources 48A, 48B, 48C, the concentration and proportions of the luminescent materials 18 in the luminescent structure 10 and the types of luminescent materials 18 utilized in the luminescent structure 10 discussed herein may be operable to generate a range of color hues of outputted light by blending the excitation light 24 with the converted light 26. It is also contemplated that the intensity of each one or more light sources 48A, 48B, 48C may be varied simultaneously, or independently, from any number of other light sources 48A, 48B, 48C.

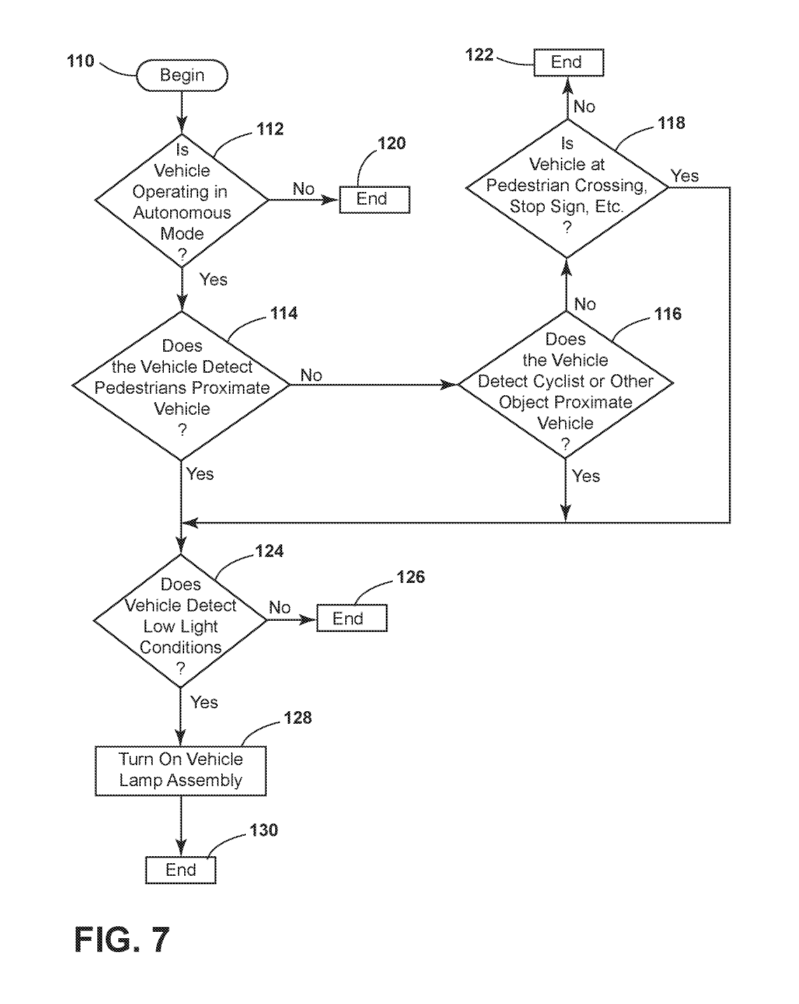

Referring to FIG. 7, according to some examples, a method for operating begins at step 110. The vehicle 28 may determine if it is currently operating in an autonomous mode at step 112. If the vehicle 28 is operated in a manual mode, the method may end at step 120. While operating, at step 114, the vehicle 28, through the sensor assembly 38 or any other device onboard the vehicle 28, may detect pedestrians proximate the vehicle 28. In addition, the vehicle 28 also may detect cyclists or other objects proximate the vehicle 28 at step 116. If the vehicle 28 does not detect a pedestrian, cyclist, or any other proximate object, the vehicle 28 may determine if it is located at a pedestrian crossing, stop sign, stop light, and/or any other location having a higher concentration of persons and objects that may be proximate the vehicle 28 at step 118. If the vehicle 28 is not near a location deemed to have a higher concentration of persons and/or objects, the process ends at step 122.

If the vehicle 28 detects a pedestrian, a cyclist, and/or any other object proximate the vehicle 28, the vehicle 28 will determine if low-light conditions exist at step 124. If low-light conditions do not exist, at step 126, the process ends. If low-light conditions do exist, the controller 54 will illuminate a desired indicia 56 along the panel 46 of the vehicle 28 at step 128. The light source 48 may stay illuminated as long as the low-light conditions exist and/or the vehicle 28 is operated in an autonomous (or semi-autonomous) mode. Once the low-light conditions no longer exist and/or the vehicle 28 is not operated in an autonomous mode, the method ends at step 130. As provided herein, the controller 54 may illuminate one or more independent indicia 56 based on the conditions detected. At each point in which the method ends 120, 122, 126, 130, the method may begin again at step 110.

Use of the present disclosure may offer a variety of advantages. For instance, use of the lamp assembly may provide notification of a vehicle state, such as operating mode, of the vehicle to proximate vehicles and/or persons. The lamp assembly may incorporate a light source therein to provide a projection onto the vehicle. The light source may be operably coupled with one or more luminescent structures. The lamp assembly may include any or all of the features provided herein and still be manufactured at low costs when compared to standard lamps and lighting assemblies.

According to various examples, a lamp assembly is provided herein. The lamp assembly includes a light source operably coupled to a panel of a vehicle. A luminescent structure is disposed on the panel and defines one or more indicia. The luminescent structure is configured to luminesce in response to receiving an excitation light emitted by the light source. A controller is configured to activate the light source based on an operational mode of the vehicle. Examples of the lamp assembly can include any one or a combination of the following features:
an engaging member positioned on the shade and configured to couple with a retaining member disposed within the vehicle to maintain the shade in a deployed position;
the luminescent structure includes at least one luminescent material configured to convert an excitation light received from the light source into a visible light;
the light source is configured as a projector lamp that produces one or more projections from an exterior member of the vehicle;
the exterior member extends outwardly from two opposing sides of the vehicle;
the light source includes a plurality of light sources that illuminate various luminescent structures on the panel of the vehicle;
the controller activates the light source once a person or object is detected proximate the vehicle;
the controller activates the light source when a light sensor detects low-light conditions surrounding the vehicle;
the controller activates the light source when a light sensor detects low-light conditions surrounding the vehicle;
the light source includes a first light source that emits a first wavelength of excitation light and a second light source that emits a second wavelength of excitation light; and/or
the light source is activated by the controller when the vehicle is operated in an autonomous mode.

Moreover, a method of illuminating a vehicle lamp assembly is provided herein. The method includes detecting an operational mode of the vehicle. Next, the controller attempts to detect a person proximate the vehicle. An environmental light level surrounding the vehicle is detected. An indicia on a vehicle is illuminated when the vehicle is in a first operational mode, the person is detected, and a low-light condition exists. Examples of the method can include any one or a combination of the following features:
the detecting an operational mode of the vehicle includes using one or more vehicle equipment to determine a presence of a passenger within the vehicle;
the detecting of persons proximate the vehicle includes using a sensor assembly;
the illuminating an indicia on a vehicle step includes activating a light source within an exterior member that extends from the vehicle;
the detecting an environmental light level surrounding the vehicle step includes using a light sensor; and/or
the illuminating an indicia on a vehicle when the vehicle is in a first operation mode step includes activating a light source when the vehicle is operated in an autonomous mode.

According to some examples, a vehicle exterior member assembly is provided herein. The vehicle exterior member assembly includes a first light source disposed within a first housing. A second light source is disposed within a second housing. The first and second light sources are operably coupled with first and second luminescent structures, respectively. A controller is configured to activate the first and second light sources based on an operational mode of a vehicle. Examples of the vehicle exterior member assembly can include any one or a combination of the following features:
the first light source is activated by the controller when the vehicle is operated in an autonomous mode;
said exterior member extends outwardly from two opposing sides of the vehicle; and/or
the controller activates the second light source once a person or object is detected proximate the vehicle.

It will be understood by one having ordinary skill in the art that construction of the described invention and other components is not limited to any specific material. Other exemplary examples of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable and/or physically interacting components and/or wirelessly interactable and/or wirelessly interacting components and/or logically interacting and/or logically interactable components. Furthermore, it will be understood that a component preceding the term “of the” may be disposed at any practicable location (e.g., on, within, and/or externally disposed from the vehicle) such that the component may function in any manner described herein.

It is also important to note that the construction and arrangement of the elements of the invention as shown in the exemplary examples is illustrative only. Although only a few examples of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary examples without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

1. A lamp assembly, comprising:
a projector lamp including a movable optical member and a sensor assembly each housed within a common exterior member of a vehicle;
a luminescent structure disposed on a panel and configured to luminesce in response to receiving an excitation light emitted by the light source;
a seat sensor configured to detect occupancy of a driver's seat; and
a controller configured to activate a light source when the vehicle is in motion and the driver's seat is unoccupied.

2. The lamp assembly of claim 1, wherein the luminescent structure includes at least one luminescent material configured to convert an excitation light received from the light source into a visible light.

3. The lamp assembly of claim 1, wherein the light source is activated by the controller when the vehicle is operated in an autonomous mode and the vehicle is in motion.

4. The lamp assembly of claim 1, wherein the projector lamp produces one or more projections from an impression on the movable optical member.

5. The lamp assembly of claim 4, wherein the exterior member extends outwardly from two opposing sides of the vehicle.

6. The lamp assembly of claim 1, wherein the light source includes a plurality of light sources that illuminate various luminescent structures on the panel of the vehicle.

7. The lamp assembly of claim 1, wherein the controller activates the light source once a person or object is detected proximate the vehicle.

8. The lamp assembly of claim 7, wherein the controller activates the light source when a light sensor detects low-light conditions surrounding the vehicle.

9. The lamp assembly of claim 7, wherein the controller deactivates the light source when the vehicle is no longer operated in an autonomous mode.

10. The lamp assembly of claim 1, wherein the light source includes a first light source that emits a first wavelength of excitation light and a second light source that emits a second wavelength of excitation light.

11. A vehicle exterior member assembly, comprising:
a first light source disposed within a first housing;
a second light source disposed within a second housing, wherein the first and second light sources are operably coupled with a first and a second luminescent structure, respectively;
a sensor assembly disposed within an exterior member along with the first and second housings, the first and second housings disposed outwardly of the sensor assembly; and
a controller configured to activate the first and second light sources based on an operational mode of a vehicle, wherein the first and second light sources illuminate an indicia on a lateral door panel of the vehicle if a person or object is on an intersecting path with the vehicle.

12. The vehicle exterior member assembly of claim 11, wherein the first light source is activated by the controller when the vehicle is operated in an autonomous mode.

13. The vehicle exterior member assembly of claim 11, wherein said exterior member extends outwardly from two opposing sides of the vehicle.

14. The vehicle exterior member assembly of claim 11, wherein the controller activates the second light source once the person or object is detected proximate the vehicle and the vehicle and the person or object are both in motion.

15. A method of illuminating a vehicle lamp assembly, comprising:
detecting an autonomous or manual mode of said vehicle;
sensing an occupancy of a driver's seat;
detecting a person proximate the vehicle;
detecting an environmental light level surrounding the vehicle; and
activating a light source to illuminate an indicia on a vehicle when the vehicle is in the autonomous mode, a driver's seat is unoccupied, a person is detected on an intersecting path with the vehicle, and a low-light condition exists.

16. The method of illuminating a vehicle lamp assembly of claim 15, wherein the detecting an operational mode of the vehicle includes utilizing one or more vehicle equipment to determine a presence of a passenger within the vehicle.

17. The method of illuminating a vehicle lamp assembly of claim 15, wherein the detecting of the person proximate the vehicle includes utilizing a sensor assembly.

18. The method of illuminating a vehicle lamp assembly of claim 15, wherein the activating the light source to illuminate the indicia on the vehicle step includes activating the light source within an exterior member that extends from the vehicle.

19. (canceled)

20. (canceled)

21. The method of illuminating a vehicle lamp assembly of claim 15, further comprising:
deactivating the light source thereby concealing the indicia when no person is detected proximate the vehicle and a low-light condition exists.

22. The method of illuminating a vehicle lamp assembly of claim 15, further comprising:
activating the light source to illuminate the indicia when the vehicle approaches an intersection.
